(19) United States
(12) Patent Application Publication
(10) Pub. No.: US 2010/0088155 A1
(43) Pub. Date: Apr. 8, 2010

(54) METHOD AND SYSTEM FOR PROCURING BIDS AND MANAGING ASSETS AND ASSET SUPPORT CONTRACTS

(75) Inventors: Christopher G. Pyle, Lake Worth, FL (US); Adam Culp, Boynton Beach, FL (US); Tina M. Lux, Boca Raton, FL (US); William Phelps, Boca Raton, FL (US); Ramon Trujillo, Boca Raton, FL (US)

Correspondence Address: SULLIVAN & WORCESTER LLP, 1666 K Street NW, Washington, DC, 20006, US

(73) Assignee: MANAGED MAINTENANCE, INC., Boca Raton, FL (US)

(21) Appl. No.: 12/571,648

(22) Filed: Oct. 1, 2009

Related U.S. Application Data
(63) Continuation-in-part of application No. 12/037,194, filed on Feb. 26, 2008.

(51) Int. Cl. G06Q 50/00; G06Q 30/00; G06Q 10/00; G06F 3/01; G06F 17/30

(52) U.S. Cl. 705/10; 705/14.53; 705/26; 705/305; 705/348; 715/733; 707/705; 707/792; 707/E17.044; 707/E17.107

(57) ABSTRACT

A method and system are provided for managing assets and asset support contracts for assets of a given entity. The method includes: (a) receiving information including an identification of each of a plurality of assets of the entity and one or more asset support contracts associated with each of the plurality of assets, the information including expiration dates for the asset support contracts; (b) creating an online repository containing the information, the online repository being remotely accessible by users associated with the entity through an online platform; (c) tracking the assets and associated asset support contracts to identify asset support contracts set to expire within a predetermined period of time; (d) automatically notifying the entity of expiring asset support contracts prior to expiration thereof; (e) procuring bids from one or more sellers of asset support contracts to replace or renew the expiring asset support contracts or to replace or dispose of assets covered by expiring asset support contracts; and (f) providing the bids to the entity.

### BACKGROUND

The present invention relates generally to managing an entity's equipment and software assets and asset support contracts (such as warranties and service/maintenance contracts) associated with the assets.

Entities such as individuals, households, businesses and other organizations often have numerous equipment and software assets. These assets are often covered by asset support contracts. Managing assets and asset support contracts for the entity can be a difficult and arduous task. The present application is directed to an improved method and system for easily, efficiently, and cost effectively managing asset support contracts and assets for the entire lifecycle of the assets.

### SUMMARY OF THE INVENTION

The present invention contemplates systems and methods of managing an entity's equipment and software assets and asset support contracts associated with the assets.

In accordance with one or more embodiments of the invention, a method is provided for managing assets and asset support contracts for assets of a given entity. The method includes: (a) receiving information including an identification of each of a plurality of assets of the entity and one or more asset support contracts associated with each of the plurality of assets, the information including expiration dates for the asset support contracts; (b) creating an online repository containing the information, the online repository being remotely accessible by users associated with the entity through an online platform; (c) tracking the assets and associated asset support contracts to identify asset support contracts set to expire within a predetermined period of time; (d) automatically notifying the entity of expiring asset support contracts prior to expiration thereof; (e) procuring bids from one or more sellers of asset support contracts to replace or renew the expiring asset support contracts or to replace or dispose of assets covered by expiring asset support contracts; and (f) providing the bids to the entity.

In accordance with one or more embodiments of the invention, a system is provided for managing assets and asset support contracts for assets of a given entity. The system includes software, database and a server computer that communicates with one or more client computers operated by one or more users associated with the entity.

Software in accordance with one or more embodiments of the present invention may include novel algorithims, formulas and applications of known algorithms and formulas.

Embodiments of the present invention further contemplate the use of Web portals for adding customized functionality to the systems and methods of the present invention.

Portals in accordance with one or more embodiments of the present invention allow users to specify custom business rules, form validation, based on those rules, and allow the building of custom reports.

Portals in accordance with the present invention may have a dashboard landing page upon login that allows the addition/removal of widgets containing various information.

The server computer receives information including an identification of each of a plurality of assets of the entity and one or more asset support contracts associated with each of the plurality of assets. The information includes expiration dates for the asset support contracts. The information is stored in a database. The server computer is operable to track the assets and associated asset support contracts to identify asset support contracts set to expire within a predetermined period of time; automatically notify the one or more users associated with the entity of expiring asset support contracts prior to expiration thereof; procure bids from one or more sellers of asset support contracts to replace or renew the expiring asset support contracts or to replace or dispose of assets covered by expiring asset support contracts; and provide the bids to the one or more users associated with said entity.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram illustrating an exemplary asset and asset support contract management system in accordance with one or more embodiments of the invention.

FIG. 2 is a flow chart illustrating an exemplary method of managing assets and asset support contracts in accordance with one or more embodiments of the invention.

FIG. 3 is an exemplary screenshot displaying a user interface dashboard in accordance with one or more embodiments of the invention.

FIG. 4 is an exemplary screenshot displaying assets of an entity in accordance with one or more embodiments of the invention.

FIG. 5 is an exemplary screenshot displaying an asset information uploading interface in accordance with one or more embodiments of the invention.

FIG. 6 is an exemplary screenshot displaying entity information in accordance with one or more embodiments of the invention.

FIG. 7 is an exemplary screenshot displaying a reports interface in accordance with one or more embodiments of the invention.

FIG. 8 is an exemplary screenshot displaying an asset report in accordance with one or more embodiments of the invention.

FIG. 9 is an exemplary screenshot displaying further information on a selected asset in accordance with one or more embodiments of the invention.

FIG. 10 is an exemplary screenshot displaying a contracts report in accordance with one or more embodiments of the invention.

FIG. 11 is an exemplary screenshot displaying contracts information in accordance with one or more embodiments of the invention.

FIG. 12 is an exemplary screenshot displaying further details of a selected contract in accordance with one or more embodiments of the invention.

FIG. 13 is an exemplary screenshot displaying a forecast report in accordance with one or more embodiments of the invention.

FIG. 14 is an exemplary screenshot displaying a user management interface in accordance with one or more embodiments of the invention.

FIG. 15 is an exemplary screenshot displaying a permissions management interface in accordance with one or more embodiments of the invention.

FIG. 16 is an exemplary screenshot displaying a group manager interface in accordance with one or more embodiments of the invention.

FIG. 17 is an exemplary screenshot displaying a group permissions management interface in accordance with one or more embodiments of the invention.

FIG. 18 is an exemplary screenshot displaying a dropdown manager interface in accordance with one or more embodiments of the invention.

FIG. 19 is an exemplary screenshot displaying a dropdown options interface in accordance with one or more embodiments of the invention.

FIG. 20 is an exemplary screenshot displaying a targeted banner advertisement in accordance with one or more embodiments of the invention.

FIG. 21 is an exemplary screenshot of a dashboard displaying active widgets.

FIG. 22 is an exemplary screenshot displaying a profile area where widgets may be activated or deactivated after they have been added to a profile.

FIG. 23 is an exemplary screenshot displaying a widget manager where widgets can be added to a profile for activation or deactivation.

FIG. 24 is an exemplary screenshot displaying a portal where customizable extra fields may be added.

FIG. 25 is an exemplary screenshot displaying a portal tracking data and activity.

FIG. 26 is an exemplary screenshot displaying a portal which allows users to specify business rules and form validation.

FIG. 27 is an exemplary screenshot displaying a portal having a robust help system.

### DETAILED DESCRIPTION

Various embodiments of the present application are directed to methods and systems for easily, efficiently, and cost effectively managing an entity's assets and asset support contracts. Briefly, and as will be described in further detail below, the system provides an online platform that allows users to track an entity's assets, monitor asset life cycles and the expiration of asset support contracts, and receive automatic notifications alerting the user of expiring asset support contracts or asset replacement or service maintenance dates. The system also provides a competitive bidding marketplace that allows users to readily obtain competitive bids for renewing or replacing expired asset support contracts, replacing assets, performing asset maintenance, or disposing of assets. The system can also be used to forecast costs associated with asset support contract renewal/replacement, and asset replacement, maintenance, or disposal. The system includes a secure searchable online repository containing information on assets and asset support contracts, including copies of the contracts. The system can provide users with tiered secured access to the stored information. In addition, the system can permit users of a related entity (e.g., a company in an asset distribution chain such as an asset manufacturer (e.g., an OEM), a distributor, a seller, or a value added reseller (VAR)) to access information on an entity's assets. The system can also allow users in the distribution and reseller chain to budget and forecast opportunities to sell extended and renewal maintenance and service contracts.

As used herein, the term asset generally refers to software or equipment. Examples of equipment include, but are not limited to, personal computers, phones, cash registers, technology systems, appliances, medical and laboratory equipment, and vehicles. Equipment can typically be described by model/type information and can be uniquely identified, e.g., by an identifier such as a serial number, UPC, VIN etc.

As used herein, an entity is any individual, household, business or other organization associated with assets, e.g., any individual, household, business or other organization that owns, leases, controls, uses, manages, manufactures, distributes, provides service on, or sells the assets. The term asset support contract generally refers to warranties and service/maintenance contracts covering assets. A warranty is generally a guarantee (usually given by a seller or manufacturer) that an asset meets certain specified requirements, and often includes a remedy such as replacement or repair if the asset fails to meet the specified requirements. A service or maintenance contract typically refers to an obligation to perform repair or maintenance services for an asset, or to provide other services relating to an asset.

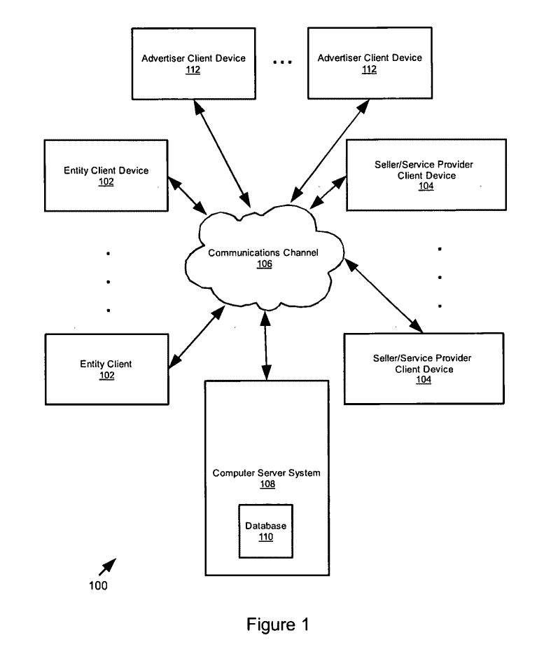

FIG. 1 illustrates an exemplary system 100 for managing assets and asset support contracts in accordance with one or more embodiments of the invention. The system 100 includes a plurality of client devices 102, 104, 112 connected via a communication channel 106 to a computer server system 108. The computer server system 108 includes a database 110 for storing asset and asset support contract information.

The client devices 102 are operated by users associated with one or more entities, whose assets and asset support contract information is stored on the server system 108. The users operate the client devices 102 to manage the entity's assets and asset support contracts.

The client devices 104 are operated by users associated with asset and asset support contract sellers and service providers. As will be described in further detail below, the sellers and service providers can participate in a competitive bidding marketplace to provide competitive bids for renewing or replacing expired asset support contracts, replacing assets, performing asset maintenance, disposing of assets, or providing other services related to the assets.

The client devices 112 are operated by users associated with advertisers who can use the system to manage targeted advertising campaigns as is described in further detail below.

The channel 106 may, e.g., be the Internet, an intranet, or other network connection. In the case of the Internet, the server computer system 108 can be one of a plurality of Web servers that are accessible by a plurality of clients such as the client devices 102, 104.

The client devices 102, 104 may, e.g., be personal computers such as a Pentium®-based desktop or notebook computer running a Windows® operating system. Alternatively, the client devices 102, 104 can be, e.g., portable communication devices such as a personal digital assistant (PDA) or a cellular telephone. The client devices 102, 104 typically include a browser, which may, e.g., be any of a variety of conventional web browsers, such as the Microsoft Internet Explorer® or Mozilla Firefox® Web browsers.

The server computer system 108 hosts a Web portal, i.e., a website gateway providing asset management services in accordance with various embodiments of the invention. The server computer system 108 maintains an online repository or database 110 of information on assets and asset support contracts of one or more entities as will be described in further detail below.

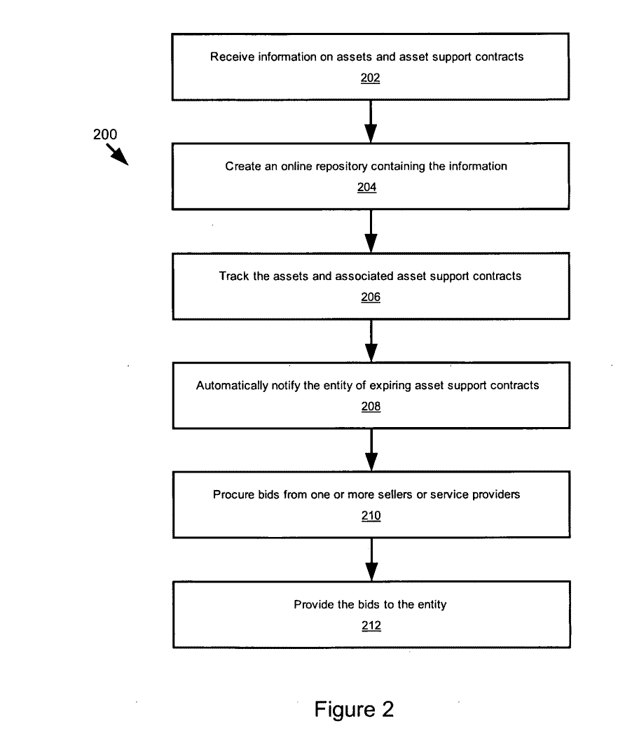

FIG. 2 is a flowchart illustrating an exemplary method 200 for managing assets and asset support contracts in accordance with one or more embodiments of the invention.

At step 202 the computer server system receives information on assets and asset support contracts of an entity. The information can, e.g., be uploaded by users of client computers 102 through a Web portal operated by the server computer system 108. The users can be, e.g., associated with an entity that owns, leases, or uses an asset or a related entity such as a manufacturer, distributor, or a seller of an asset. The information includes an identification of the assets, which can include model/type information as well as a unique identifier such as a serial number associated with the asset. The information on the asset support contracts identifies the assets covered by the asset support contracts and includes data on expiration dates for the asset support contracts. In accordance with one or more embodiments, additional information on the assets can also be provided, including, e.g., product replacement or maintenance service dates for the assets.

At step 204, the computer server system stores the information in a database or online repository 110 that can be remotely accessed by users associated with an entity.

At step 206, the computer server system 108 tracks the assets and asset support contracts of an entity to identify asset support contracts that are set to expire within a given period of time. The server computer system can also track other information relating to the assets including product replacement or maintenance service dates for the assets.

At step 208, the computer server system automatically issues a notification to a user associated with the entity of expiring asset support contracts prior to expiration. The computer server system can also notify users of upcoming product replacement or maintenance service dates.

At step 210, the computer server system 108 procures bids from one or more sellers of asset support contracts to replace or renew expiring asset support contracts. The computer server system 108 can also procure bids from one or more disposal services for disposing of assets at the end of asset lifecycles. In some embodiments, the user uses the system to generate requests for quotations (RFQs) prior to the system procuring bids from the sellers.

At step 212, the computer server system provides the bids to users associated with the entity. The users can then decide whether or not to accept any of the bids, or take some other action.

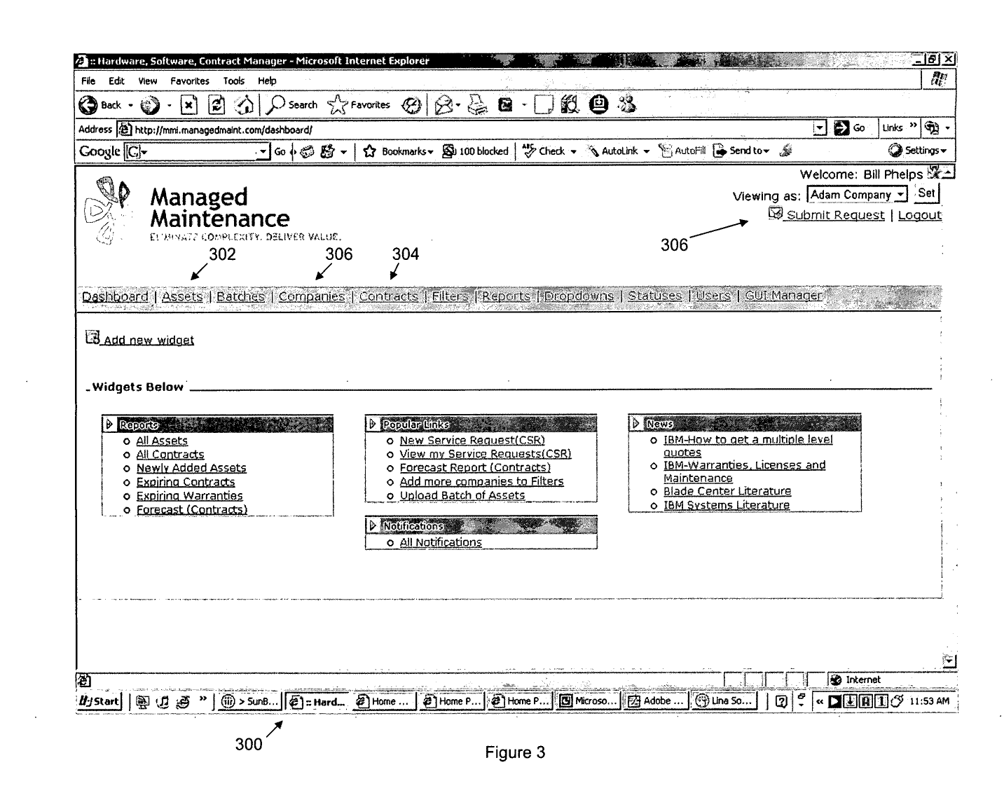

FIGS. 3-20 are exemplary screen shots of a user interface in accordance with one or more embodiments of the invention. The user interface is displayed to a user of the system on client device 102 for use in managing an entity's assets and asset support contracts.

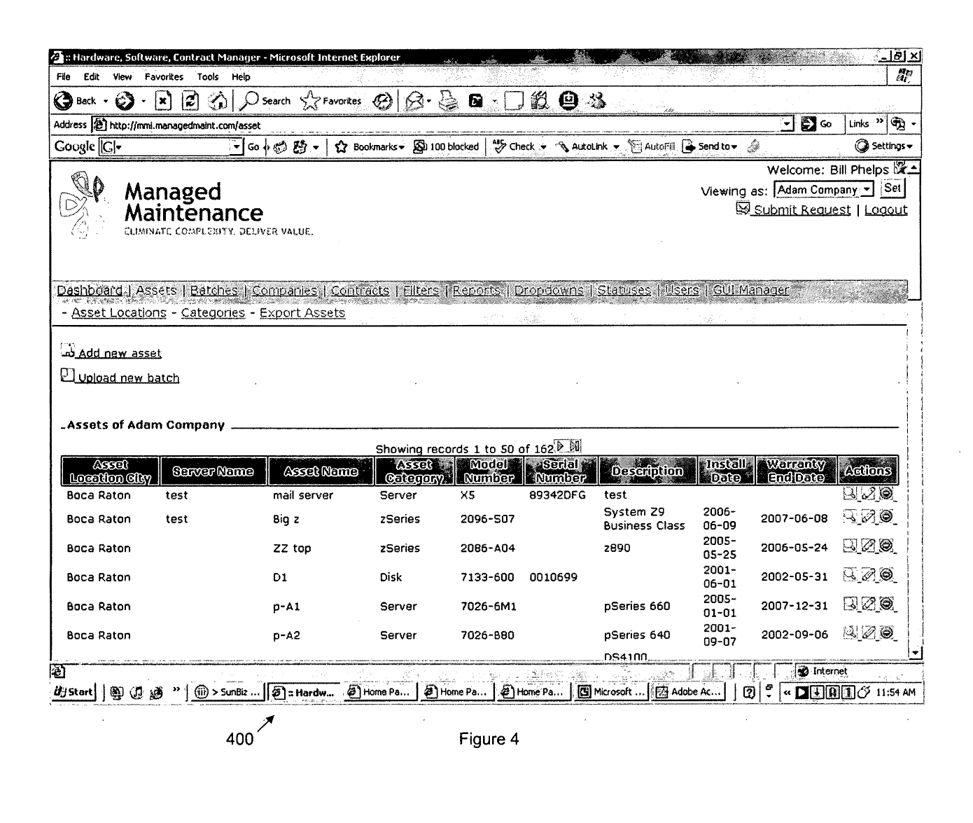

FIG. 3 illustrates an exemplary dashboard 300 displayed to the user. The dashboard 300 provides the user with access to the various features of the system. For example, when the “Assets” tab or link 302 is selected on the dashboard 300, a listing of all the assets of the user's company can be displayed to the user as shown, e.g., in the screenshot 400 of FIG. 4. The assets can be categorized and sorted in various ways including by location, name, category, model number, serial number, description, installation date, and warranty end date, etc. The user can use the screen to perform inventory tracking and data mining.

If the “Contracts” tab 304 of the FIG. 3 dashboard 300 is selected, the system will provide a listing (not shown) of asset support contracts associated with the assets of the entity. The contracts can be categorized and sorted in various ways including, e.g., by contract number, description, start date, end date, and billing frequency.

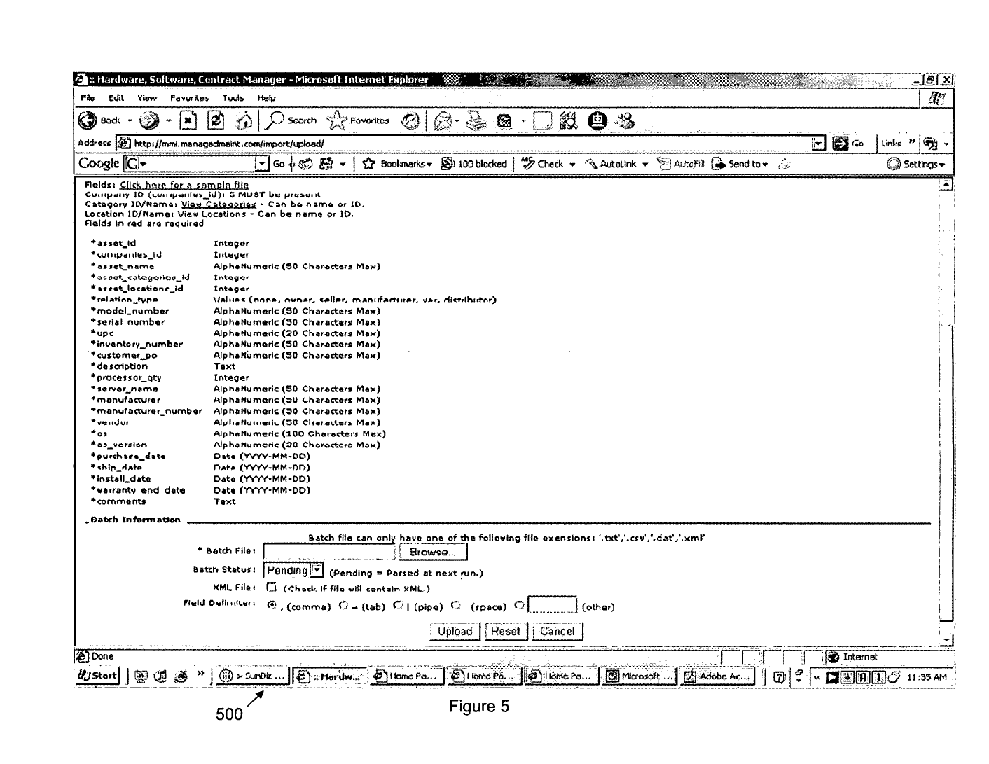

The user can add assets to the list of assets for an entity by uploading information on the assets. The assets can be added individually, or as a group of assets. FIG. 5 is a exemplary screenshot 500 that illustrates how the user can upload batch files describing multiple assets to be added. When batch files are uploaded, the system can auto populate various fields in the database, including, e.g., the asset ID, the company ID, the asset name, asset category, asset location, model number, serial number, purchase date, warranty end date, etc.

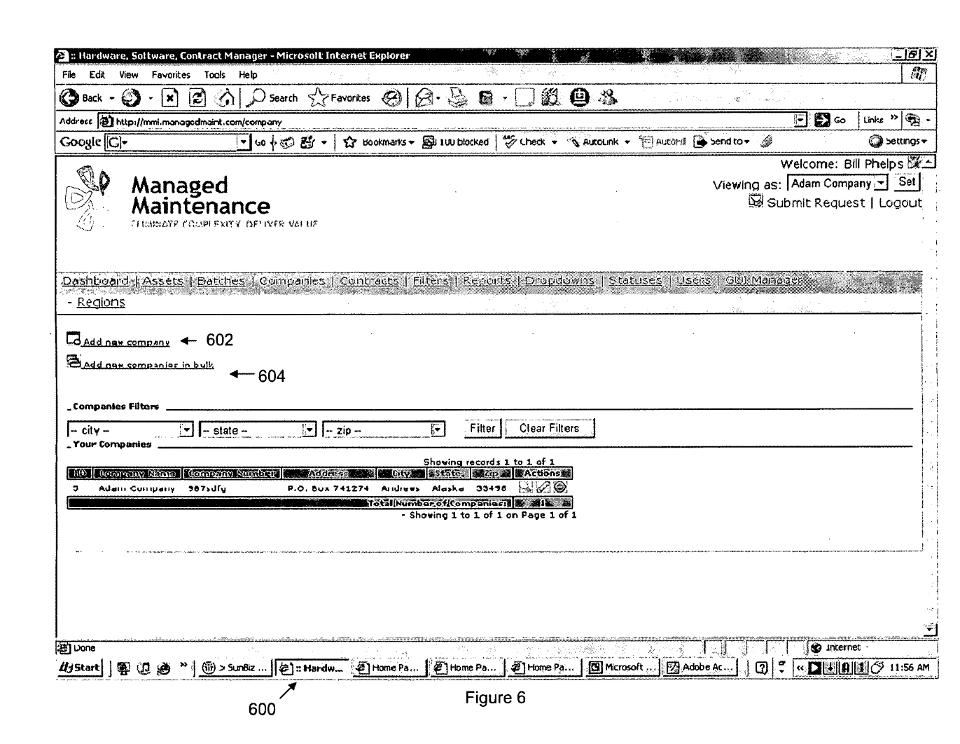

FIG. 6 is an exemplary screenshot 600 illustrating information about an entity when the “Companies” tab 306 is selected on the FIG. 3 dashboard 300. The screen identifies the entity associated with the asset information.

In accordance with certain embodiments of the invention, assets can be associated with multiple related entities. As indicated above, the system can permit users of a related company (e.g., a company in an asset distribution chain such as an asset manufacturer (e.g., an OEM), a distributor, a seller, or a value added reseller (VAR)) to access information on an entity's assets. The system allows an entity to add one or more related child companies that can access information on assets. The assets of the entity and related child companies can be stored on the system and accessed by authorized users. Information on related companies can be added by selecting “Add New Company” link 602 or “Add New Companies In Bulk” link 604 in FIG. 6.

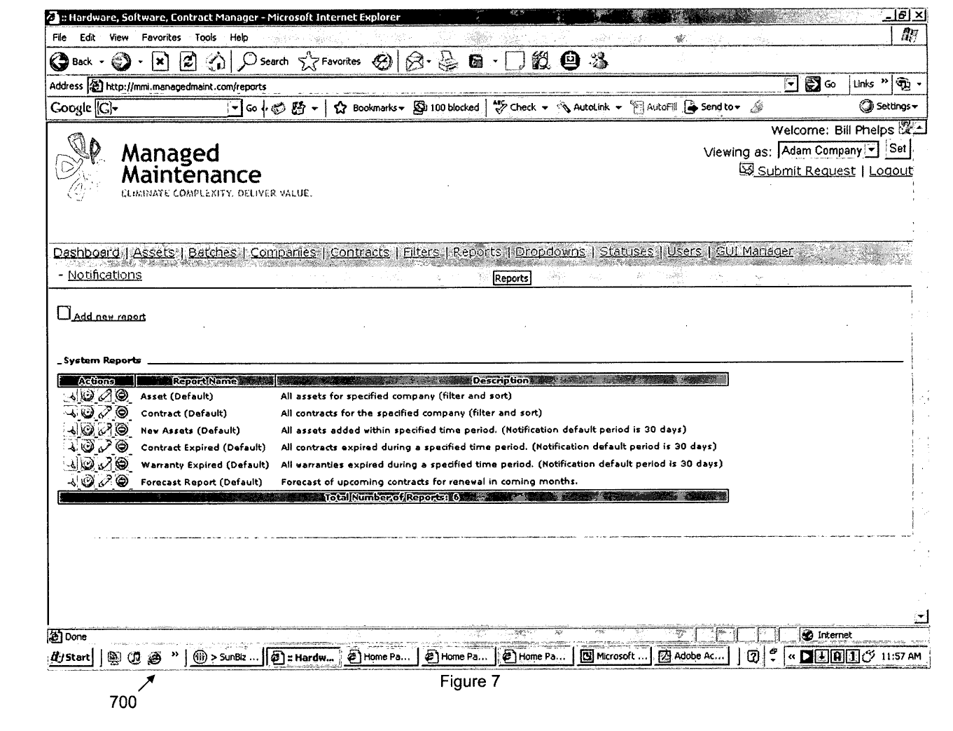

The system allows various types of reports (including management and compliance reports) to be generated relating to assets and asset support contracts. FIG. 7 is an exemplary screenshot 700 illustrating examples of different reports that can be generated for an entity.

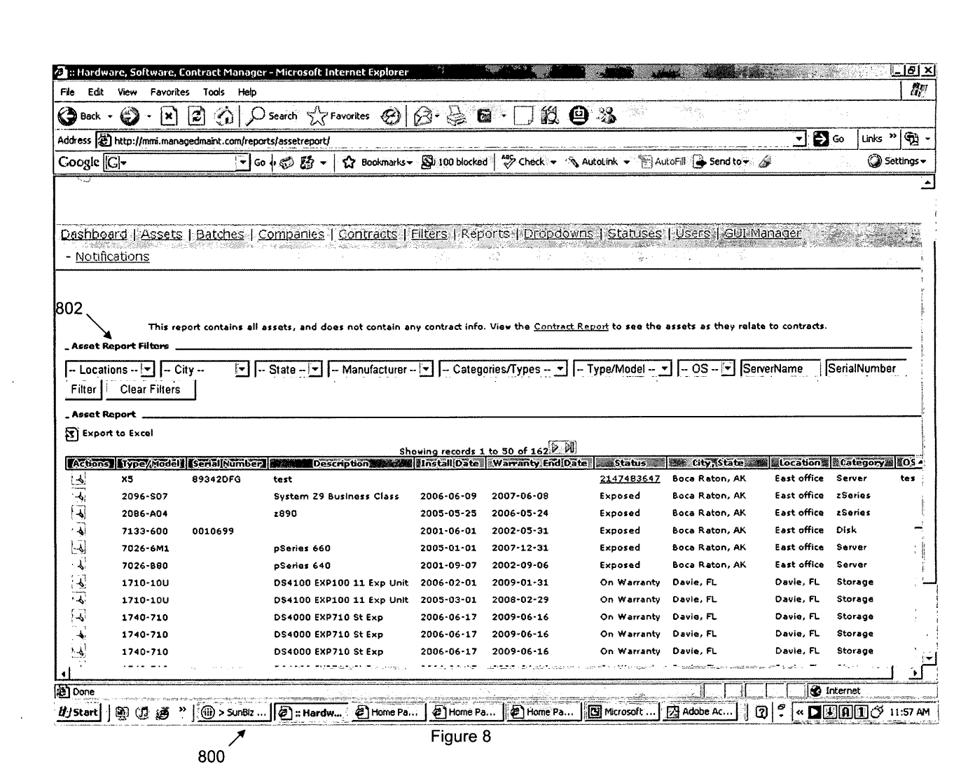

FIG. 8 illustrates an exemplary asset report 800. This screen lists an entity's assets and various asset report filters 802 that can be selected to generate particular reports. For example, assets can be filtered according to location, manufacturer, category, type/model, operating system, server name, and serial number. Reports can be exported to spreadsheets, if desired.

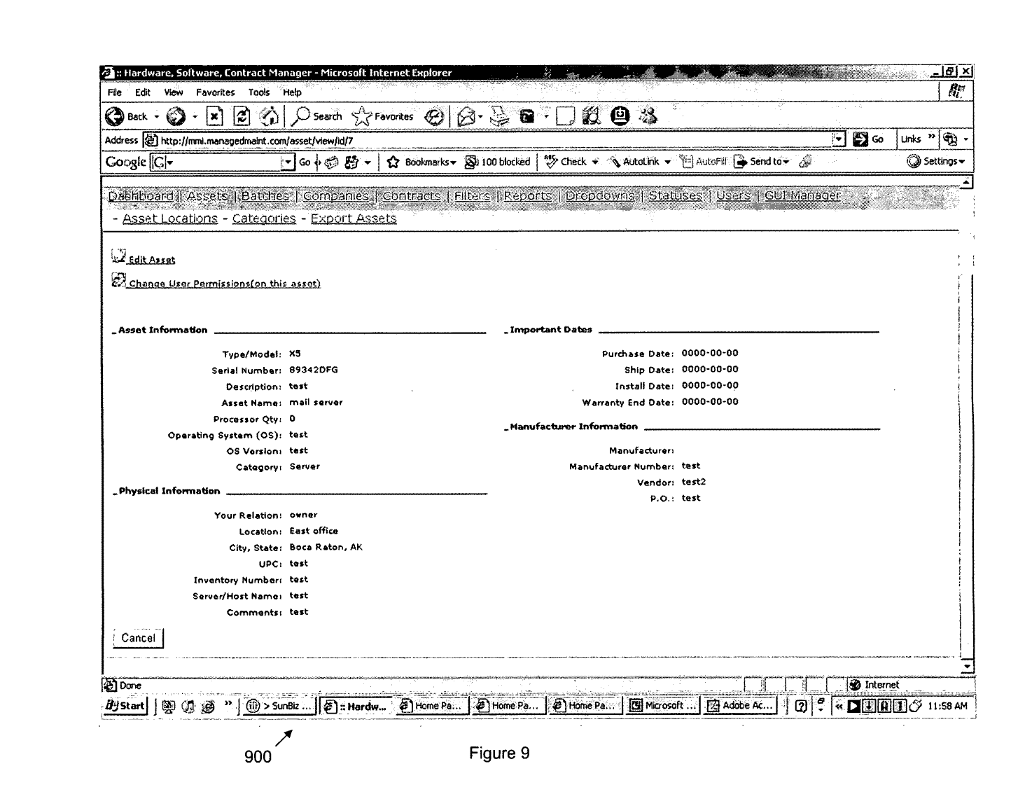

If the user desires further information on a particular asset, he or she can select the particular asset in FIG. 8 to obtain further information as shown in the drill down screenshot 900 of FIG. 9, which provides further information on the selected asset.

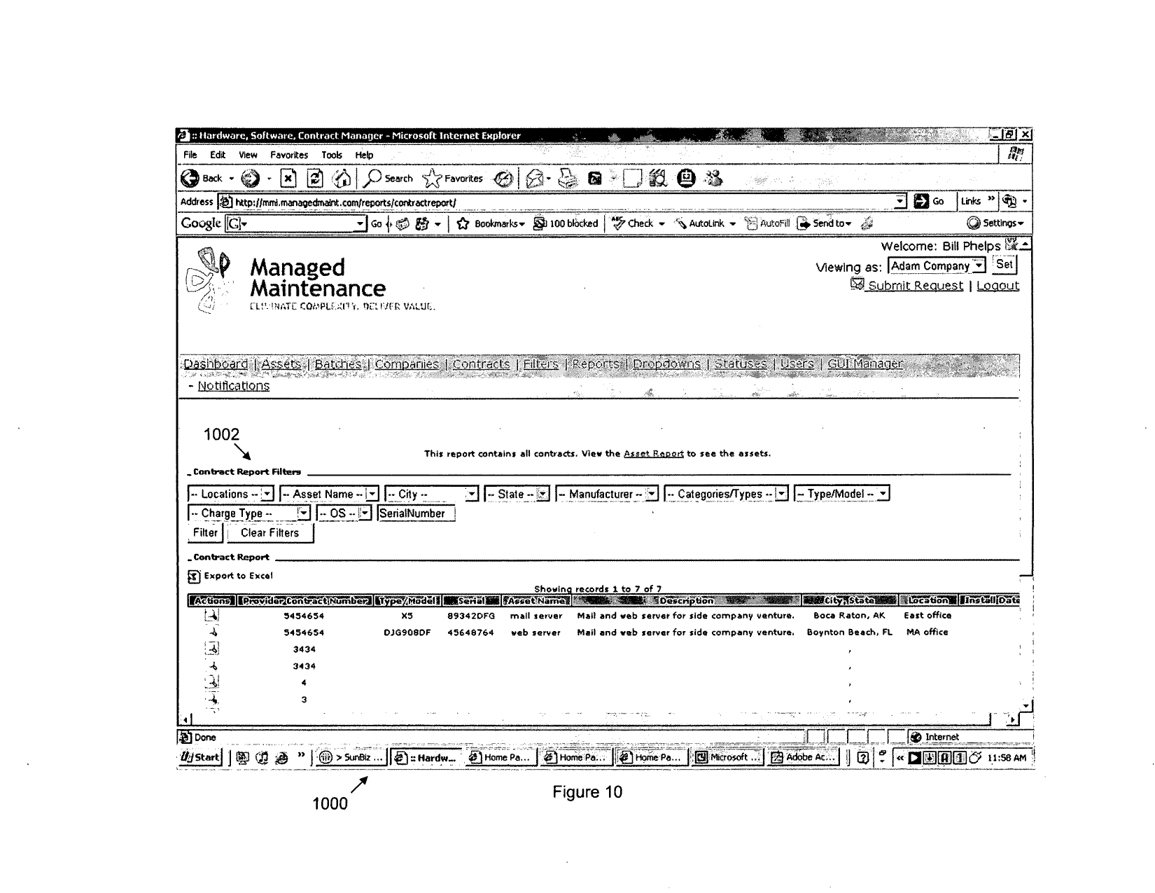

FIG. 10 illustrates an exemplary contracts report 1000, which shows an entity's asset support contracts and various report filters 1002 that can be selected to generate particular reports. For example, contracts can be filtered according to asset location, asset name, asset manufacturer, asset category/type, and asset type/model. The user can access copies of signed contracts stored in the database.

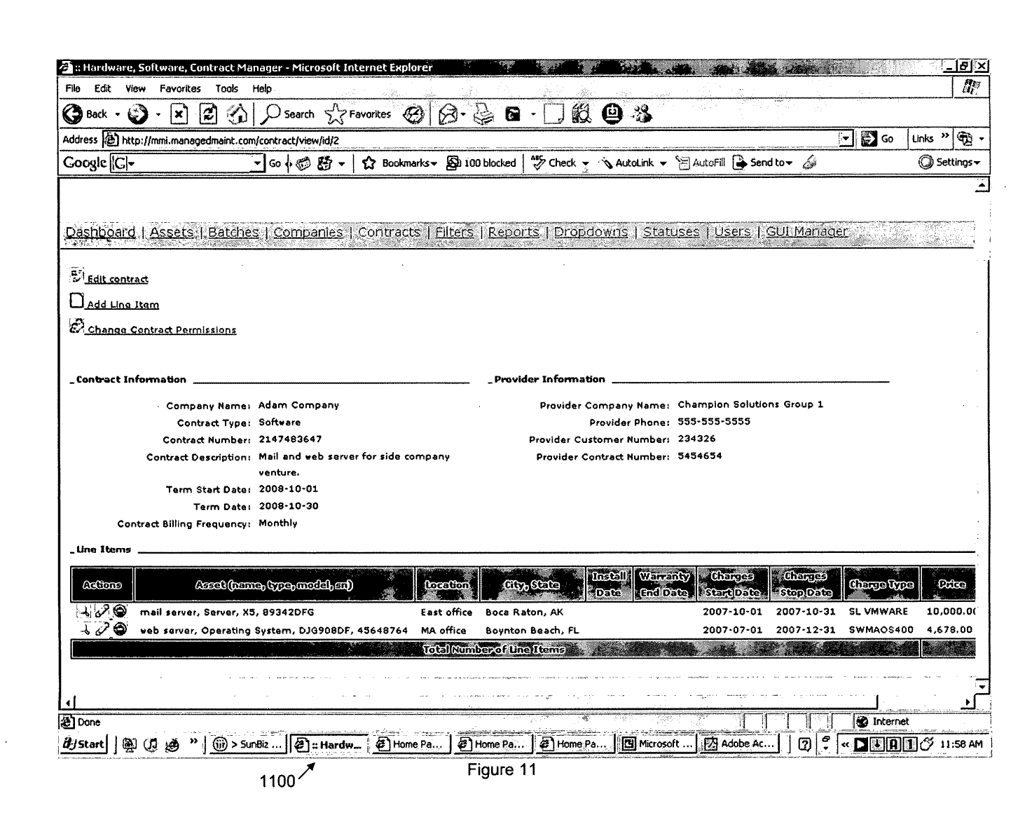

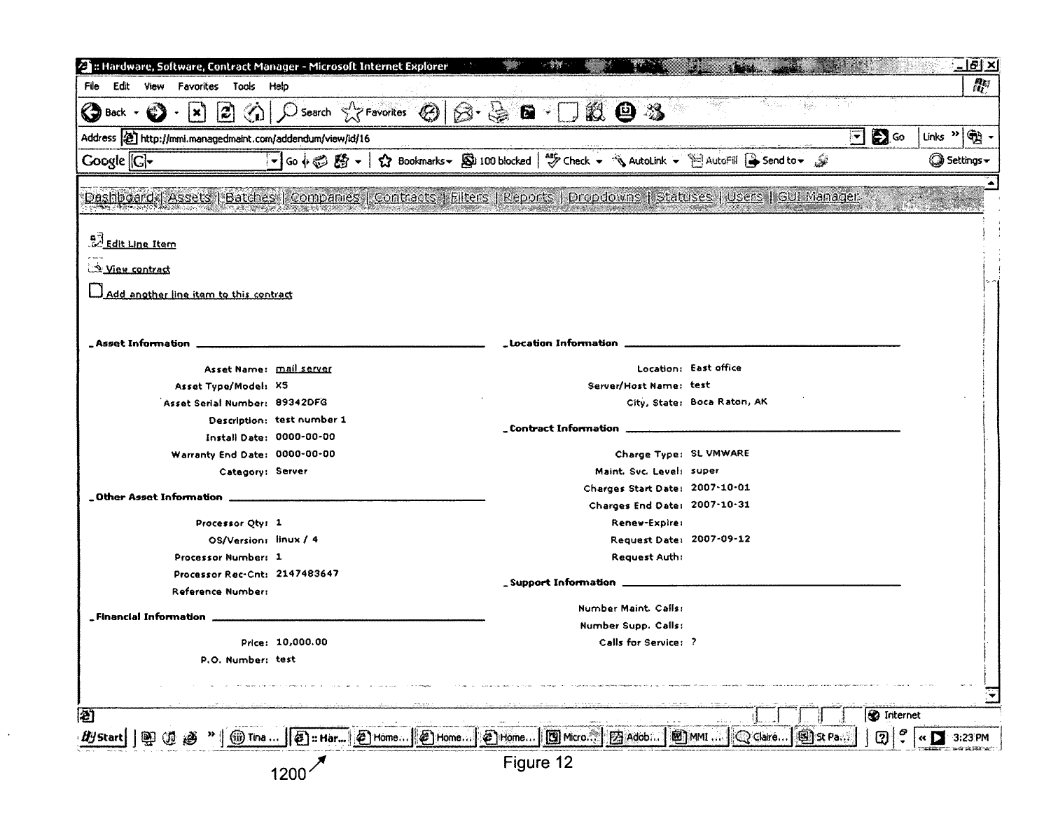

FIG. 11 illustrates an exemplary screenshot 1100 shown when the “Contracts” tab 304 is selected on the FIG. 3 dashboard. The user can edit or add contract information and contract permissions. Further details of the contract can be obtained after selecting a particular contract as shown, e.g., in the drill down screenshot 1200 of FIG. 12. The further details include the line item detail of assets associated to the contract.

The system can provide additional screenshots (not shown) allowing users to view and edit automatic notifications. For example, a user can modify when a notification will be sent and to what address, as well as the frequency of notifications.

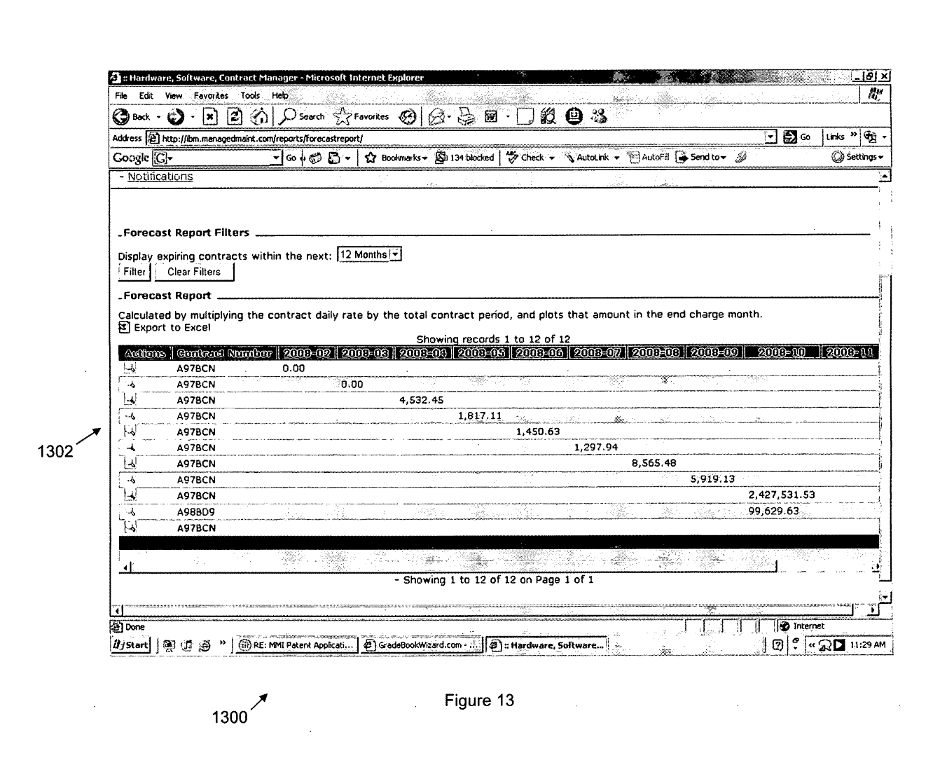

The system can also allow a user to generate forecasts reports relating to contracts expiring over a given period of time. For example, as shown in the exemplary screenshot 1300 of FIG. 13, a forecast report is shown for asset support contracts expiring within each month of a year. For each month, the system displays estimated costs 1302 associated for replacing or renewing expiring asset support contracts. In some embodiments, the system calculates forecasted costs based on historical data, i.e., based on previous costs of assets and asset support contracts.

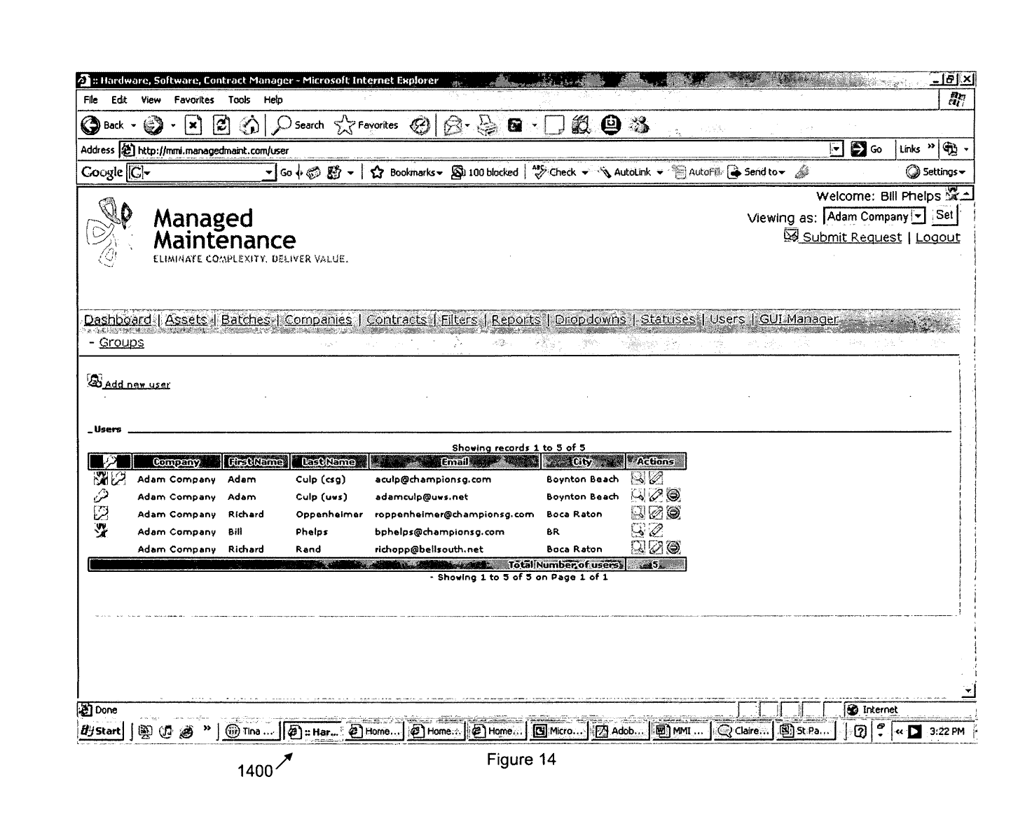

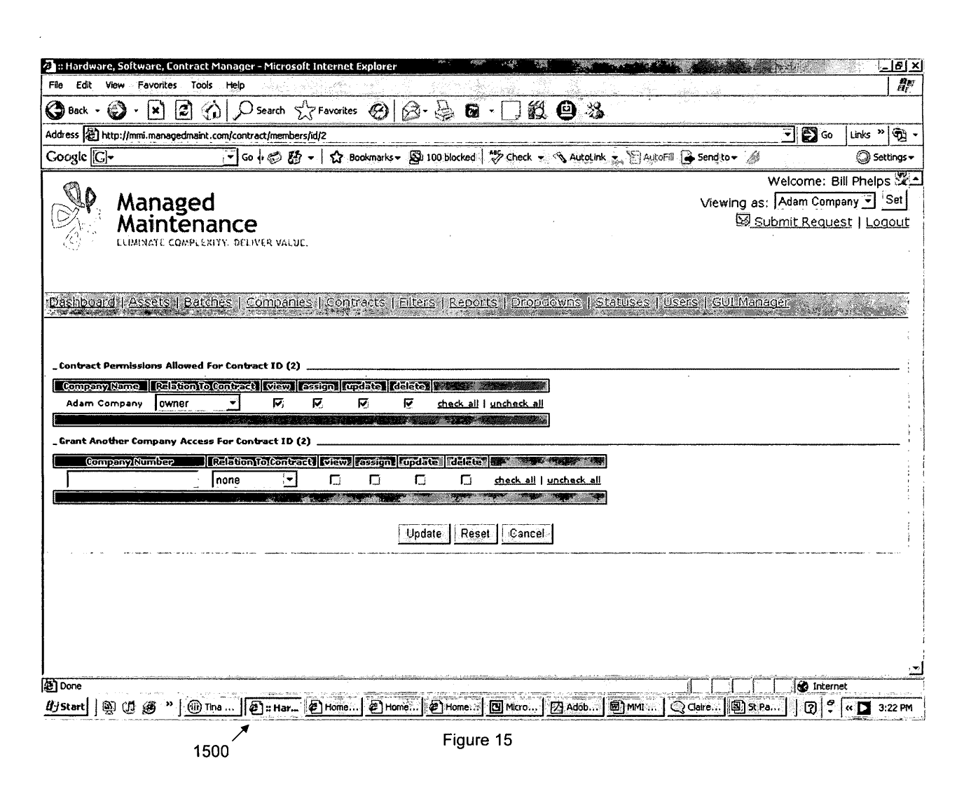

FIG. 14 illustrates an exemplary screen 1400 allowing a user (an administrator in this case) to manage users for an entity. The administrator can set different permissions for different users within the same entity. For example, as shown in the screenshot 1500 of FIG. 15, an administrator can change permissions relating to a contract, e.g., allow a related company access (view, assign, update, or delete) information on a contract.

In some embodiments, the server system 108 is operated by or on behalf of a manufacturer (e.g., an OEM), distributor, seller, or value added reseller (VAR) of an asset or a seller of asset support contracts. The entity that uses, owns, leases, or manages the assets is provided access to the data on the server system, allowing that entity to better manage the assets and asset support contracts, and to forecast renewal and support costs. In some embodiments, the entity using the assets can also use the system to manage other assets (i.e., assets other those assets purchased from the manufacturer, distributor, seller, or reseller) on the server system 108. The entity that uses the assets can have access to information on all of its assets, and the entity that sells assets can be allowed to access only information relating to assets it has sold.

In accordance with certain embodiments, the system tracks the user, and filters content based on user. For example, in each session, the system can follow the user as he or she navigates through information stored in the database. The system can track what entity the user is associated with, and allow the user access to data he or she has been granted permission to access.

The system can also track entities that are related to the user's entity and filter content accessible to the user according to permissions granted to the user. The system allows users to “act” as if they are associated with another entity, if they have permission to do so. This can be done using the dropdown “filter” menu at the top of various pages of the interface (e.g., as shown by reference number 306 in FIG. 3), which provides a list of possible child companies the user has permission to “act” on behalf of. The system tracks different permissions of the user as he or she acts as associated with different entities.

In certain embodiments, the system provides users with access to a “filter” manager that enables users to add/delete companies from the dropdown “filter” menu. Company Administrators typically have authority to make these changes, and can grant authority to other users to make these changes as well.

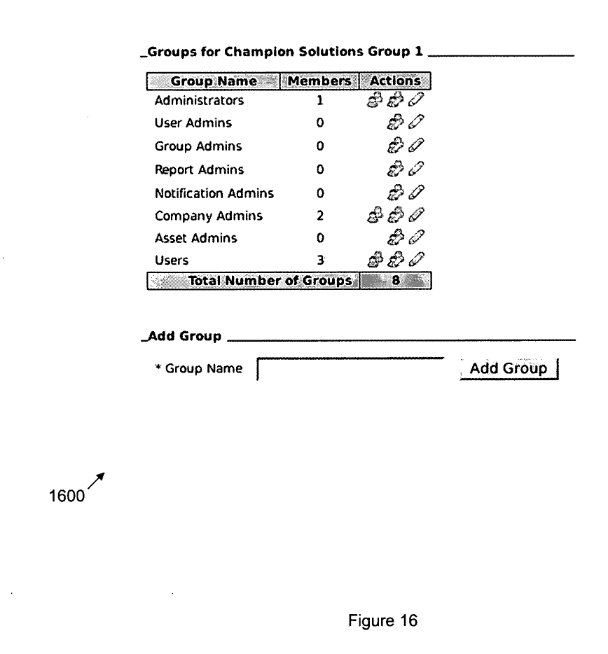

In certain embodiments, users can belong to various groups, each of which can be assigned different permissions. The system provides an Access Control List (ACL), which specifies the permissions. For example, users of an administrators group may have read, write, view, delete permissions based on the ACL, while users in another group may only have view permissions. The system preferably provides a Group Manager, which allows an entity to add a new group, which can then be assigned permissions, or to edit groups. FIG. 16 illustrates an exemplary dialog that allows a user to view all of the groups within an entity, the users within a group, and also to add a new group. A user can add or remove members of a group using, e.g., a drag and drop method.

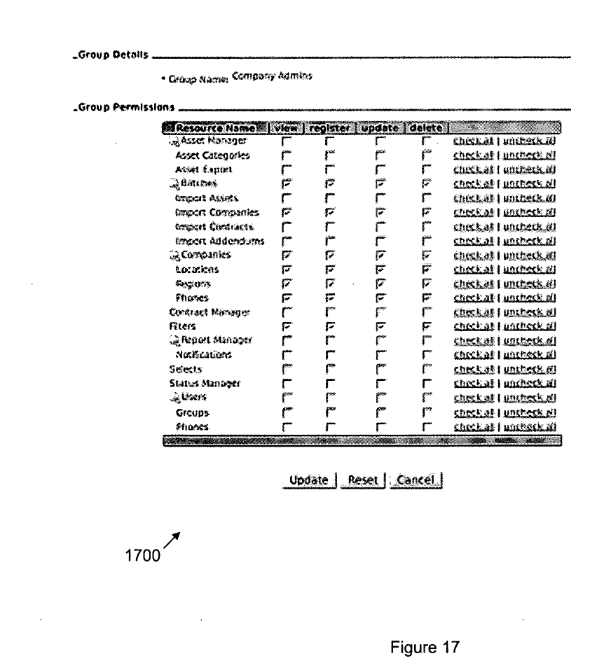

FIG. 17 illustrates an exemplary dialog 1700 that allows a user to assign permissions to a group. In this figure, icons can be selected to pinpoint particular items. For example, expanding “Asset Manager” allows permissions to be set for “Asset Categories” and “Asset Export”.

In certain embodiments, the system utilizes a multi-tiered filtering algorithm to reduce the number of choices within a filter in reports. For example a report may have 7 filter dropdown boxes, and when an item is selected in one of the boxes, all other boxes refill with relevant data based on that selection as queried “real-time” from the database.

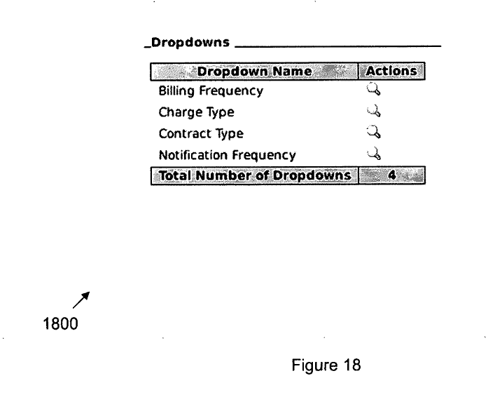

For many sites, it is common to have many dropdown menus throughout the site that are the same. Reusing these dropdown menus can make it easier for standardization and by using normalization methods keep the data clean and prevent having the same item named many different ways. Programmers have become accustomed to creating a database table to manage each dropdown individually. In accordance with certain embodiments of the invention, the system provides one table that allows for management of category names, dropdown value, dropdown label, and a dropdown property sort as shown in the exemplary dialog 1800 of FIG. 18.

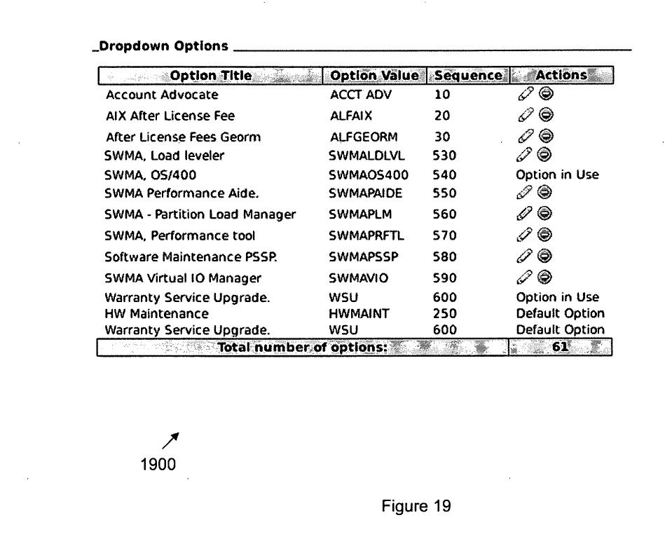

FIG. 19 is an exemplary screenshot 1900 illustrating items within a dropdown that can be edited. A user can see which options are used in data records and cannot be changed or deleted, and which options are default options and therefore cannot be changed.

In certain embodiments, the system allows a notification such as an email to be sent to specific users within an entity or related entity, for certain activities. For example, if a new user signs up under an existing company, another pre-designated user will receive a notification email to authorize the new user. Also, if a new Customer Service Request (CSR) is entered into the system, a pre-designated user will receive a notification email that there are communications waiting.

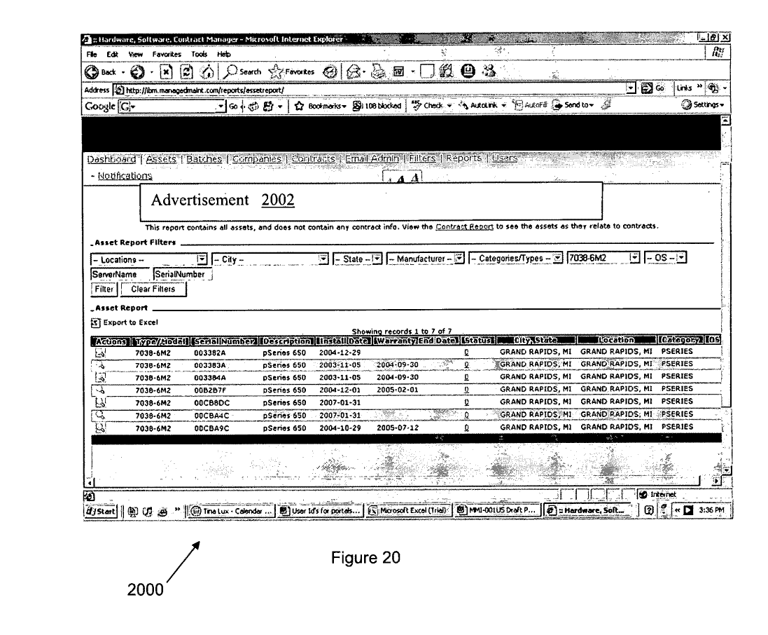

In some embodiments, the system can be used to display targeted advertising (e.g., in the form of banner advertisements) to users requesting information on their assets. FIG. 20 is an exemplary screenshot 2000 illustrating information transmitted to a user requesting particular information on an entity's assets. For example, the information requested could be all assets of a particular type/model for an entity. In accordance with some embodiments, the system generates and displays to the user an advertisement 2002 selected based on the information requested by the user. The advertisement could be, e.g., information on a replacement product for assets of that type/model.

In certain embodiments of the present invention, Web portals allow users to specify custom business rules, and also form validation, based on those rules which dynamically add functionality to the forms within the portal. These rules and validation can be added to the Contracts, Assets, and Line Item(Addendum) forms. These rules apply to GUI, API, and batch importer systems. The portals allow for the building of custom reports where the user can specify what module they wish to query against, and then select what fields to return. Custom reports may then be stored for later usage.

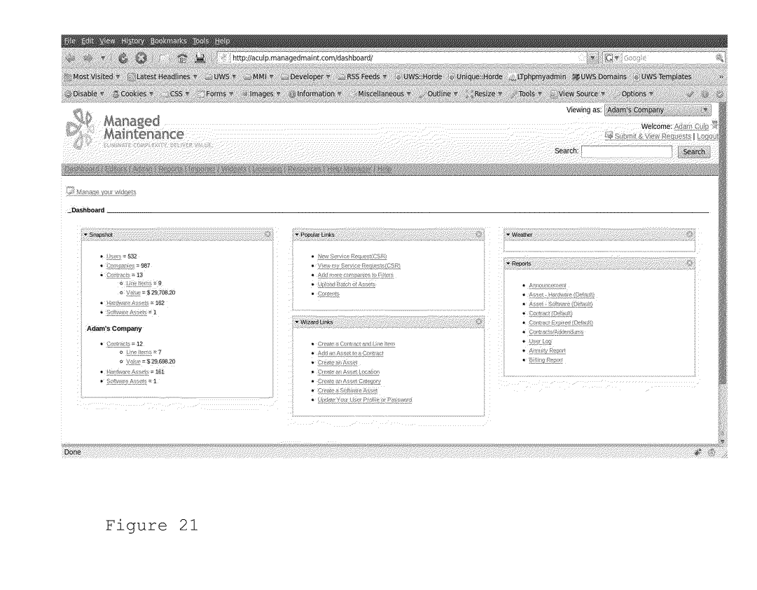

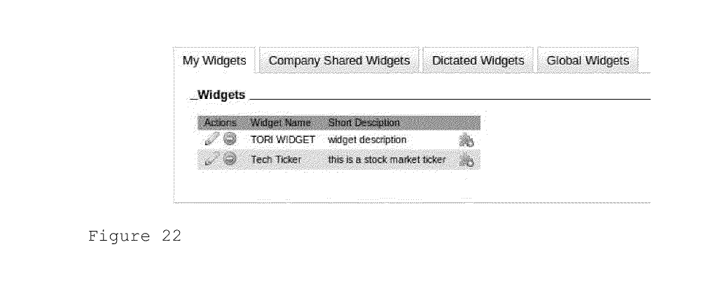

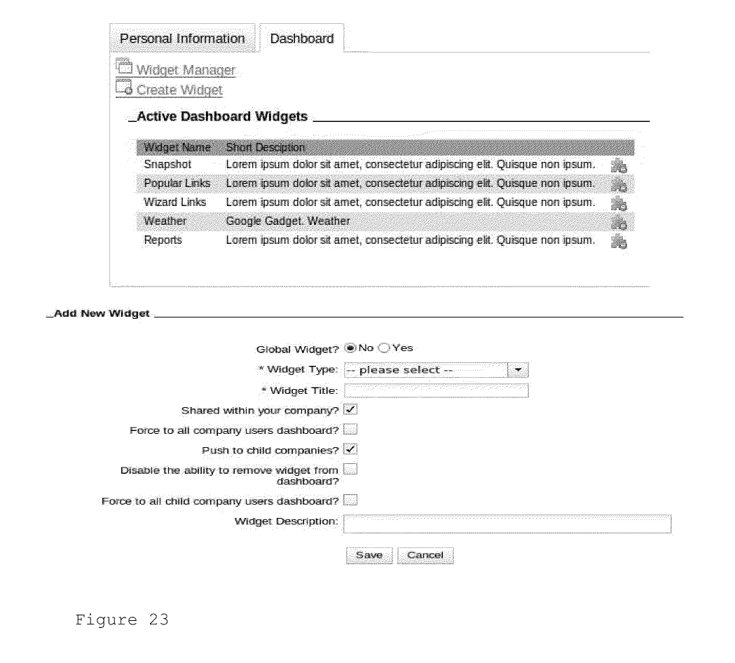

For example a portal may have a dashboard landing page upon login that allows the addition/removal of widgets containing various information. Thus, a user can create, activate/deactivate, share with others, and dictate widgets. FIG. 21 provides an exemplary screenshot of a dashboard displaying active widgets. As can be seen in FIG. 22, widgets can be activated or deactivated based on the user's preference using the widget creator in the “Widget Manager”. Widgets can then be added to a profile for activation or deactivation, as seen in FIG. 23.

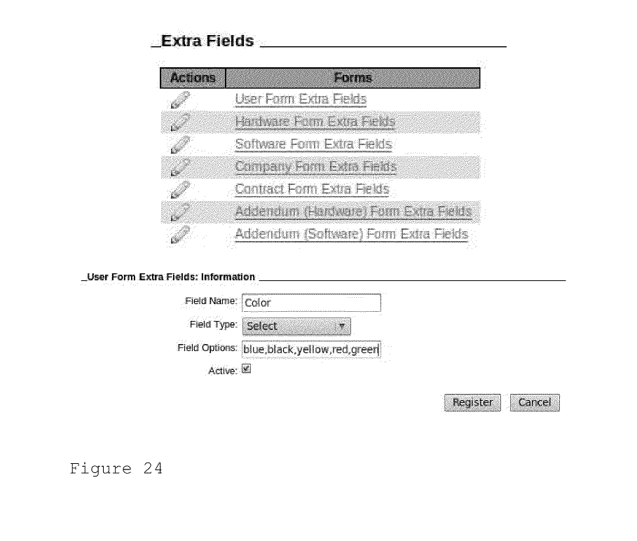

Embodiments of the present invention may also include portals that allow the addition of customizable (extra) fields in the certain modules including, but not limited to, Users, Assets, Company, Contract, Line Items(Addendum). A company can add these extra fields to themselves, push them to all child companies, or push to specified child companies. FIG. 24 provides an exemplary screenshot displaying a portal where customizable extra fields may be added.

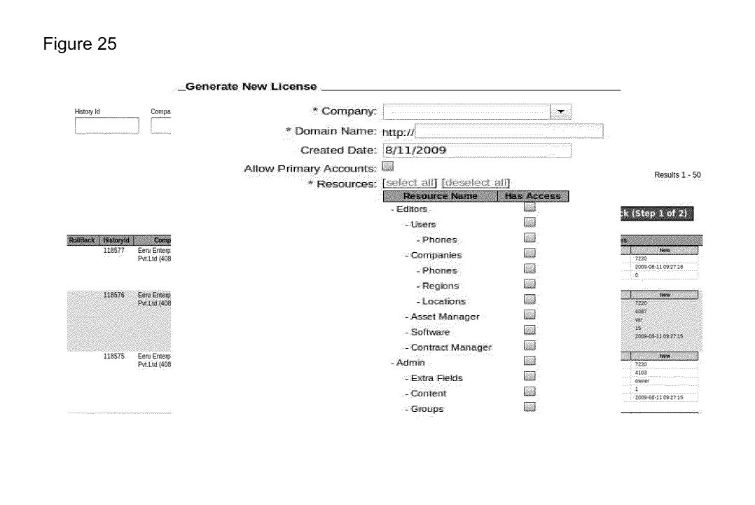

Embodiments of the present invention may also include portals for tracking the history of data and that allows the rollback to a previous data state. The portal may track all activity by a logged in user and store the activity into the database for statistics gathering. FIG. 25 provides an exemplary screenshot displaying a portal for tracking data and activity.

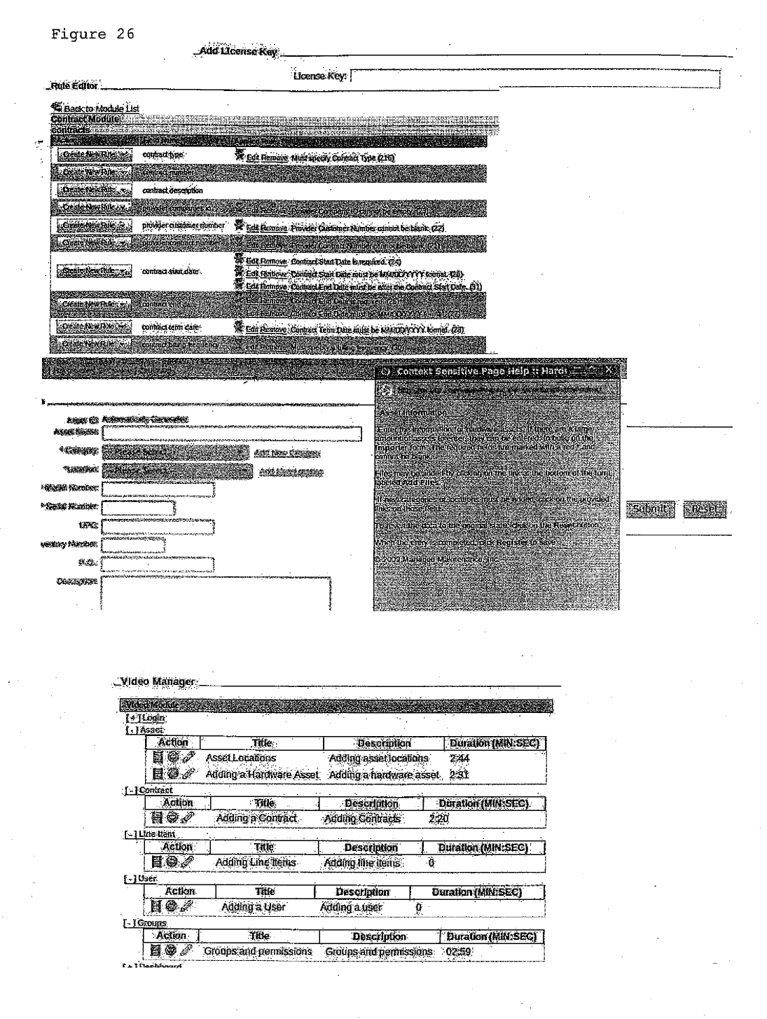

Embodiments of the present invention may also include portals for allowing users to specify business rules, and also form validation, based on those rules which dynamically add functionality to the forms within the portal. These rules and validation maybe be added to the Contracts, Assets, and Line Item(Addendum) forms. These rules apply to GUI, API, and batch importer system. FIG. 26 provides an exemplary screenshot displaying a portal which allows users to specify business rules and form validation.

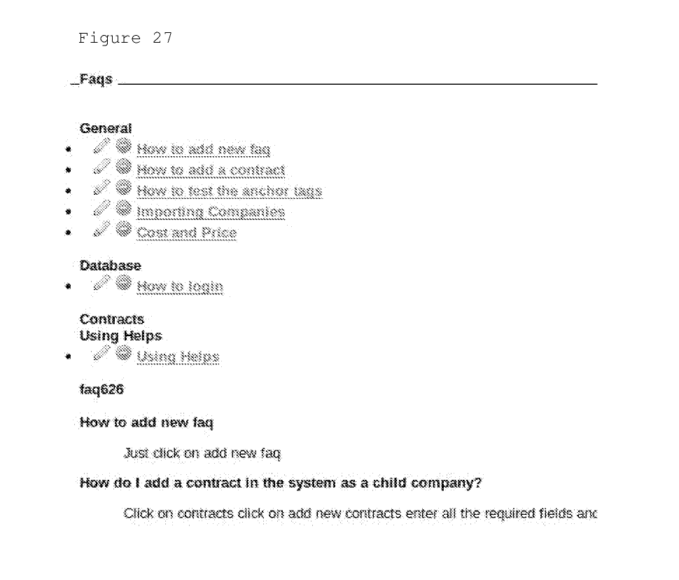

As shown in FIG. 27, embodiments of the present invention may also include portals containing a robust help system. Such a help system my include using context sensitive help on most screens, a FAQ's page for commonly asked questions, as well as a video manager containing help videos where a voice walks the viewer through common tasks as they watch a computer screen and see the mouse click on the needed items.

The systems and methods for managing assets and asset support contracts described herein may be implemented in software, and accordingly one of the preferred implementations of the invention is as a set of instructions (program code) in a code module resident in the random access memory of the server computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A method for managing assets and asset support contracts for assets of a given entity, the method comprising:
(a) receiving information including an identification of each of a plurality of assets of the entity and one or more asset support contracts associated with each of the plurality of assets, the information including expiration dates for the asset support contracts;
(b) creating an online repository containing the information, the online repository being remotely accessible by users associated with the entity through an online platform;
(c) tracking the assets and associated asset support contracts to identify asset support contracts set to expire within a predetermined period of time;
(d) automatically notifying the entity of expiring asset support contracts prior to expiration thereof;
(e) procuring bids from one or more sellers of asset support contracts to replace or renew the expiring asset support contracts or to replace or dispose of assets covered by expiring asset support contracts; and
(f) providing the bids to the entity.

2. The method of claim 1 wherein users access information from the online repository through a Web portal.

3. The method of claim 2, wherein users specify custom business rules through the Web portal.

4. The method of claim 2, wherein users add customizable fields through the Web portal.

5. The method of claim 2, wherein users track and stores data history through the Web portal.

6. A system for managing assets and asset support contracts for assets of a given entity, the system comprising:
a server computer providing an online platform that includes a Web portal communicating with one or more client computers operated by one or more users associated with the entity, said server computer receiving information including an identification of each of a plurality of assets of the entity and one or more asset support contracts associated with each of the plurality of assets, the information including expiration dates for the asset support contracts; and
a database for storing the information;
wherein the server computer is operable to track the assets and associated asset support contracts to identify asset support contracts set to expire within a predetermined period of time; automatically notify the one or more users associated with the entity of expiring asset support contracts prior to expiration thereof; procure bids from one or more sellers of asset support contracts to replace or renew the expiring asset support contracts or to replace or dispose of assets covered by expiring asset support contracts; and provide the bids to the one or more users associated with said entity.

7. The system of claim 6, the Web portal allows users to specify custom business rules.

8. The system of claim 6, wherein the Web portal allows users to add customizable fields.

9. The system of claim 6, wherein the Web portal allows users to track and store data history.

10. The system of claim 6, wherein the Web portal comprises a help system.

11. The system of claim 6 wherein the information further includes product replacement or maintenance service dates for each of the assets of the entity, and wherein the server computer tracks the product replacement or maintenance service dates, automatically notifies the entity of upcoming product replacement or maintenance service dates, and procures bids for asset replacement, asset disposal, or maintenance service for said assets.

12. The system of claim 6 wherein the asset support contracts include warranties, maintenance contracts, or service contracts.

13. The system of claim 6 wherein the computer system receives competitive bids from a plurality of sellers of asset support contracts, replacement assets, asset maintenance services, or asset disposal services.

14. The system of claim 6 wherein the server computer requests permission from the entity to procure the bids.

15. The system of claim 6 wherein the server computer system sends requests for quotations to one or more sellers of asset support contracts, replacement assets, asset maintenance services, or asset disposal services.

16. The system of claim 6 wherein the server computer provides an online platform that includes a competitive bidding marketplace for procuring bids.

17. The system of claim 6 wherein the server computer system provides secured access to the information to the entity.

18. The system of claim 6 wherein the server computer provides designated users of the entity different levels of access to the information.

19. The system of claim 6 wherein the server computer provides users of a related entity with access to the information, and allows users of the related entity to act as if they are associated with said entity.

20. The system of claim 6 wherein the server computer tracks permissions of the users accessing the information.

21. The system of claim 6 wherein the server computer provides a search feature to assist the entity in identifying particular assets or asset support contracts stored at the online repository.

22. The system of claim 6 wherein the information includes electronic document copies of the asset support contracts.

23. The system of claim 6 wherein the server computer further generates reports based on the information.

24. The system of claim 6 wherein the server computer further generates a forecast of costs associated with replacing or renewing the expiring asset support contracts, replacing or disposing assets covered by expiring support contracts product, or providing maintenance services for the assets.

25. The system of claim 6 wherein the server computer generates a forecast for a distributor, reseller, retailer, VAR and/or service provider indicating sales opportunities for extended maintenance and service agreements.

26. The system of claim 6 wherein the server computer uses the information in the online repository to create and manage an advertising campaign.

27. The system of claim 6 wherein the server computer further receives a request from a user for information on given assets, and transmits said information to the user to be displayed to the user along with an advertisement based on said information.
